(19) United States
(12) Patent Application Publication
(10) Pub. No.: US 2023/0142685 A1
(43) Pub. Date: May 11, 2023

(54) BUFFER BODY FOR LEAD-ACID BATTERY AND PACKING STRUCTURE OF LEAD-ACID BATTERY

(71) Applicant: GS Yuasa International Ltd., Kyoto-shi, Kyoto (JP)

(72) Inventors: Yuya NAKAMURA, Shizuoka (JP); Yu KOJIMA, Shizuoka (JP); Kazunari ANDO, Shizuoka (JP)

(21) Appl. No.: 17/918,456

(22) PCT Filed: Mar. 30, 2021
(86) PCT No.: PCT/JP2021/013433

§ 371 Date: Oct. 12, 2022

(30) Foreign Application Priority Data
May 18, 2020 (JP) 2020-086449

(51) Int. Cl. H01M 50/477; H01M 10/16

(52) U.S. Cl. CPC H01M 50/477; H01M 10/16

(57) ABSTRACT

Provided is a buffer body 5 for a lead-acid battery 1 having two terminals 12, the buffer body 5 being made of pulp mold, the buffer body 5 including, in a state where the buffer body 5 is disposed outside a first wall portion 22 facing the two terminals 12 among wall portions of a packing box 2 in which the lead-acid battery 1 is packed: a second wall portion 50 facing the first wall portion 22; and a first recessed portion 53A formed at a position facing the terminal 12 in the second wall portion 50 and recessed in a direction away from the first wall portion 22.

### TECHNICAL FIELD

The technology disclosed in the present specification relates to a buffer body for a lead-acid battery and a packing structure of a lead-acid battery.

### BACKGROUND ART

Conventionally, when an object to be transported is transported, a buffer body is disposed around the object to be transported to protect the object from an impact during transportation (see, for example, Patent Document 1).

Specifically, the packaging structure described in Patent Document 1 includes a bottom box made of a cardboard plate, lower buffer bodies made of pulp mold that are stored on both sides of the bottom box and receive both sides of a lower end of a main body portion of an object to be packaged (corresponding to an object to be transported), upper buffer bodies made of pulp mold that are applied to both sides of an upper end of the main body portion of the object to be packaged received by the lower buffer bodies, and a main body box made of a cardboard plate whose lower end is opened to cover all of them.

### PRIOR ART DOCUMENT

### Patent Document

Patent Document 1: JP-A-2005-313942

### SUMMARY OF THE INVENTION

### Problems to be Solved by the Invention

However, conventionally, a problem unique to a case of transporting a lead-acid battery as an object to be transported has not been studied.

The present specification discloses a technique for improving a problem unique to a case of transporting a lead-acid battery.

### Means for Solving the Problems

A buffer body for a lead-acid battery having two terminals, the buffer body being made of pulp mold, the buffer body including, in a state where the buffer body is disposed outside a first wall portion facing the two terminals among wall portions of a box in which the lead-acid battery is packed: a second wall portion facing the first wall portion; and a first recessed portion formed at a position facing the terminal in the second wall portion and recessed in a direction away from the first wall portion.

### Advantages of the Invention

It is possible to improve the problem unique to a case of transporting a lead-acid battery.

### BRIEF DESCRIPTION OF THE DRAWINGS

FIG. 1 is a perspective view of a lead-acid battery according to a first embodiment.

FIG. 2 is a perspective view of a box in which the lead-acid battery is packed.

FIG. 3 is a perspective view of an outer box.

FIG. 4 is a cross-sectional view of a packing structure of the lead-acid battery.

FIG. 5 is a schematic view illustrating a form of falling of the outer box.

FIG. 6 is a perspective view of an upper buffer body as viewed obliquely from below.

FIG. 7 is a bottom view illustrating positions of recessed portions formed in the upper buffer body.

FIG. 8 is a cross-sectional view of the packing structure of the lead-acid battery (a cross-sectional view corresponding to line A-A illustrated in FIG. 7).

FIG. 9A is a schematic view illustrating a state where the upper buffer body is disposed on the box.

FIG. 9B is a schematic view illustrating a state where the upper buffer body illustrated in FIG. 9A is rotated by 180 degrees around a straight line perpendicular to a first wall portion of the box.

FIG. 10 is a perspective view of the upper buffer body as viewed obliquely from above.

FIG. 11A is a side view of a short side surface of the upper buffer body.

FIG. 11B is a side view of a long side surface of the upper buffer body.

FIG. 12 is a schematic view illustrating a state where the outer box is laid on its side to accommodate the lower buffer body.

FIG. 13 is a top view illustrating a state where a granular absorbent material is disposed in recessed portions of the lower buffer body.

### MODE FOR CARRYING OUT THE INVENTION

### (Outline of Present Embodiment)

(1) A buffer body for a lead-acid battery having two terminals, the buffer body being made of pulp mold, the buffer body including, in a state where the buffer body is disposed outside a first wall portion facing the two terminals among wall portions of a box in which the lead-acid battery is packed: a second wall portion facing the first wall portion; and a first recessed portion formed at a position facing the terminal in the second wall portion and recessed in a direction away from the first wall portion.

For example, when a lead-acid battery for replacement of a lead-acid battery mounted on an automobile is transported by air transportation or the like, a box in which the lead-acid battery is packed is accommodated in an individual outer box and transported. When the outer box in which the box is accommodated is transported, the stacked outer boxes may fall due to load collapse or the like. When the outer box falls, the outer box may fall with its terminal of the lead-acid battery facing downward. When the outer box falls with its terminal facing downward, the impact from the floor concentrates on the terminal, and the impact cannot be absorbed by a buffer body, and the lead-acid battery may be damaged. When the lead-acid battery is damaged, the electrolyte solution stored in the lead-acid battery leaks out, which may affect the surroundings. Conventionally, this has not been sufficiently studied.

The buffer body described above includes, in a state of being disposed outside the first wall portion of the box; the second wall portion facing the first wall portion; and the first recessed portion formed at a position facing the terminal in the second wall portion and recessed in the direction away from the first wall portion. Since the lead-acid battery is packed in the box, when the box falls with its terminal facing downward, the first wall portion of the box is pressed downward by the terminal. Since the first recessed portion is formed in the second wall portion of the buffer body at a position facing the terminal, the first wall portion pressed downward by the terminal bends downward using the space of the first recessed portion to function as a cushion. As a result, the impact applied to the terminal is buffered, and the impact is dispersed to the entire first wall portion of the box. Therefore, it is possible to reduce the possibility that the impact concentrates on the terminal and the lead-acid battery is damaged.

Furthermore, as a result of intensive studies, the inventors of the present application have found that if the buffer body is made of pulp mold, even if the lead-acid battery is damaged and the electrolyte solution leaks out, the leaked electrolyte solution can be absorbed to some extent by the buffer body.

According to the buffer body described above, the possibility that the lead-acid battery is broken and the electrolyte solution leaks out can be reduced, and even if the electrolyte solution leaks out, the electrolyte solution can be absorbed to some extent by the buffer body made of pulp mold. Therefore, it is possible to improve a problem unique to the case of transporting the lead-acid battery (a problem that the lead-acid battery may be damaged during transportation, and the electrolyte solution may leak out and affect the surroundings).

Here, the lead-acid battery mounted on an automobile has been described as an example, but the lead-acid battery is not limited to one mounted on an automobile. For example, the lead-acid battery may be mounted on a motorcycle or may be used for other purposes.

(2) The two terminals may be arranged on the same side in a direction orthogonal to an imaginary straight line connecting the two terminals with respect to a center of the box in the direction orthogonal to the imaginary straight line when viewed from a direction perpendicular to the first wall portion of the box, and the first recessed portion may be formed on both sides in the orthogonal direction with respect to the center of the box, and the first recessed portion may face the terminal even when the buffer body is disposed while being rotated by 180 degrees around a straight line perpendicular to the first wall portion.

For example, assuming that the first recessed portion is formed only on one side in the direction orthogonal to the imaginary straight line connecting the two terminals with respect to the center of the box in the direction orthogonal to the imaginary straight line, when the buffer body is disposed, it is necessary to pay attention to the direction of the buffer body such that the first recessed portion faces the terminal. Therefore, operability is deteriorated.

According to the buffer body described above, the first recessed portion is formed on both sides in the direction orthogonal to the imaginary straight line with respect to the center of the box, and even when the buffer body is rotated by 180 degrees around the straight line perpendicular to the first wall portion of the box, the first recessed portion faces the terminal. Therefore, an operator does not need to pay attention to the direction of the buffer body when arranging the buffer body. Therefore, operability is improved.

(3) The second wall portion may have a projecting portion being hollow and protruding in a direction away from the first wall portion, and a tip of the projecting portion may be at the same position as a tip of the first recessed portion or be farther from the first wall portion than the tip of the first recessed portion.

According to the buffer body described above, since the tip of the projecting portion is at the same position as the tip of the first recessed portion or is farther from the first wall portion of the box than the tip of the first recessed portion, when the box falls with its terminal facing downward, an impact from the floor is received by the projecting portion (or the first recessed portion and the projecting portion). Since the projecting portion being hollow is crushed when receiving an impact, the projecting portion is crushed to buffer the impact, so that it is possible to buffer the impact when the box falls with its terminal facing downward.

(4) The buffer body may further include: a third wall portion having a frame shape that is continuous with an outer peripheral edge portion of the second wall portion and surrounds the box; and a fourth wall portion having a frame shape that is connected to the third wall portion and surrounds the third wall portion, and a space may be provided between the third wall portion and the fourth wall portion.

The box has a wall portion continuous with the first wall portion at a right angle. When the box falls, the box may fall with its wall portion continuous at the right angle facing downward. According to the above buffer body described above, since the space is provided between the third wall portion and the fourth wall portion, when the box falls with its wall portion continuous at the right angle facing downward, the fourth wall portion bends using the space between the fourth wall portion and the third wall portion (or the third wall portion bends using the space between the third wall portion and the fourth wall portion), thereby functioning as a cushion that buffers the impact applied to the lead-acid battery. Therefore, it is possible to buffer the impact when the box falls with its wall portion continuous at the right angle facing downward.

(5) The fourth wall portion may be inclined so as to approach the box as being away from the second wall portion, and a rib having a surface parallel to a wall portion continuous with the first wall portion at a right angle among wall portions of the box may be formed on an outer surface of the fourth wall portion.

When accommodating the buffer body in the outer box as a preliminary preparation, the operator accommodates the buffer body in the outer box in a state where the buffer body stands (state where the outer surface of the fourth wall portion faces downward) for ease of operation. In this case, when the fourth wall portion is inclined, the buffer body easily falls, and operability is deteriorated.

According to the buffer body described above, the rib having the surface parallel to the wall portion continuous with the first wall portion of the box at a right angle is formed on the outer surface of the fourth wall portion. Since the wall portion continuous at the right angle and the wall portion of the outer box are parallel to each other, when the buffer body is accommodated in a standing state, the parallel surface of the rib comes into contact with the wall portion of the outer box, so that the buffer body is less likely to fall. Therefore, operability is improved.

(6) A second recessed portion recessed so as to be away from a corner portion of the box may be formed in the second wall portion and the third wall portion.

When the box falls, the box may fall with its corner portion facing downward. When the box falls with its corner portion facing downward, the impact concentrates on the corner portion, and the impact cannot be absorbed by the buffer body, and the lead-acid battery may be damaged. Conventionally, this has not been sufficiently studied.

According to the buffer body described above, since the second recessed portion recessed so as to be away from the corner portion of the box is formed in the second wall portion and the third wall portion, it is possible to suppress concentration of an impact on the corner portion of the lead-acid battery when the box falls with its corner portion facing downward. Therefore, it is possible to reduce the possibility that the impact concentrates on the corner portion and the lead-acid battery is damaged.

(7) The box and the buffer body may be transported in a state of being put in a bag, and, on a surface of the second wall portion facing a side opposite to the first wall portion, a flat surface for pressing an adhesive tape when an opening of the bag is fixed with the adhesive tape may be formed.

When the opening of the bag is fixed with the adhesive tape, the operator presses the adhesive tape against the second wall portion in order to reliably attach the adhesive tape. At this time, if there is unevenness on the surface of the second wall portion facing the side opposite to the first wall portion, it becomes difficult to attach the adhesive tape, and operability is deteriorated.

According to the buffer body described above, since the flat surface is formed on the surface of the second wall portion facing the side opposite to the first wall portion, the operator can easily attach the adhesive tape by pressing the adhesive tape against the flat surface. Therefore, operability is improved.

(8) A packing structure of a lead-acid battery having two terminals, the packing structure including: the box in which the lead-acid battery is packed; an outer box in which the box is accommodated; and the buffer body for a lead-acid battery according to any one of claims 1 to 7, which is disposed outside the first wall portion of the box inside the outer box.

According to the packing structure described above, it is possible to improve the problem unique to the case of transporting the lead-acid battery.

### First Embodiment

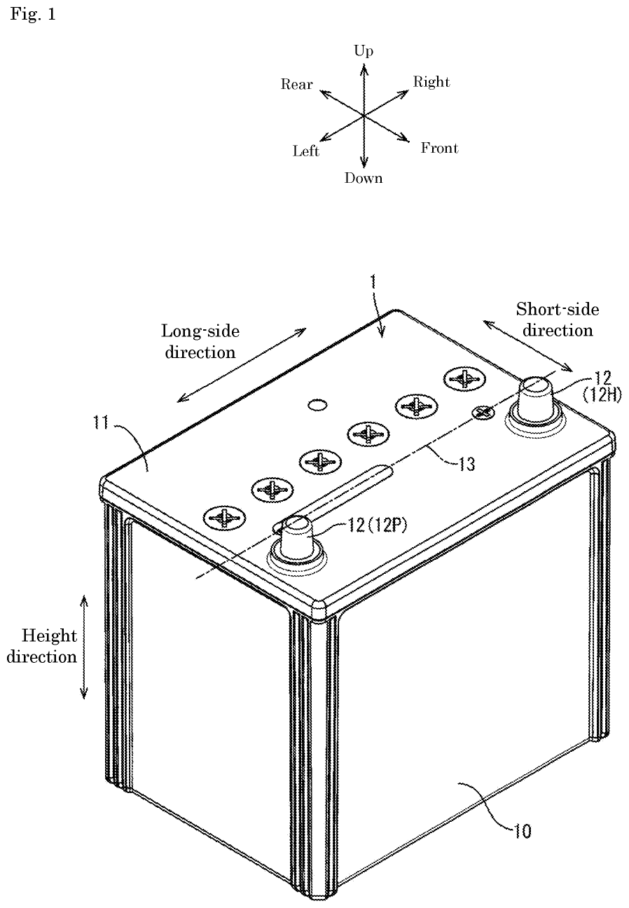

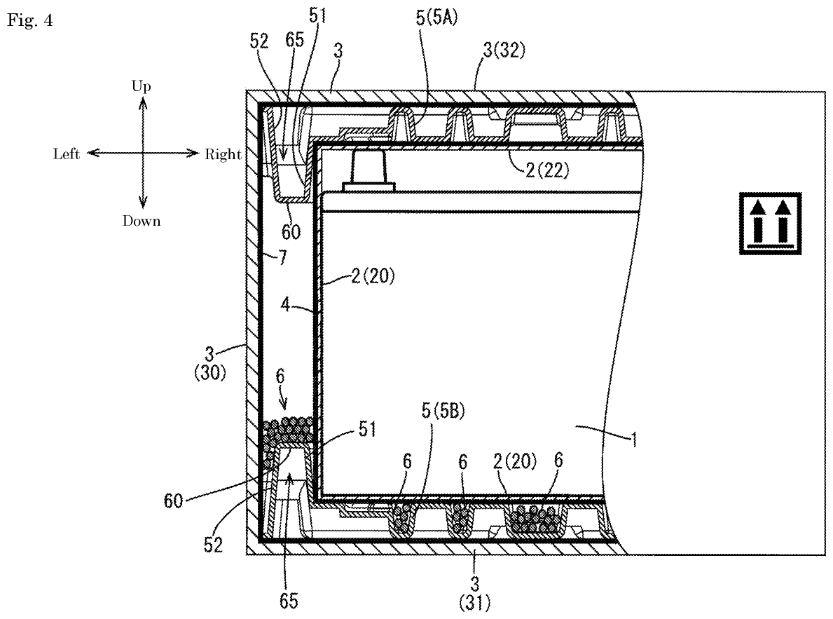

A first embodiment will be described with reference to FIGS. 1 to 13. In the following description, the vertical direction is based on the vertical direction illustrated in FIG. 4. In the following description, reference numerals of the drawings may be omitted for the same components except for a part thereof.

### (1) Lead-Acid Battery

A lead-acid battery 1 according to a first embodiment will be described with reference to FIG. 1. The lead-acid battery 1 is a lead-acid battery for starting an engine that is mounted on an automobile and supplies electric power to an engine starter (cell motor).

The lead-acid battery 1 has a rectangular shape in top view, and includes a container 10 made of synthetic resin and having an upper side opened, and a lid member 11 made of synthetic resin and closing an opening of the container 10. An element and an electrolyte solution are accommodated in the container 10. Two terminals 12 (a positive electrode external terminal 12P and a negative electrode external terminal 12N) protruding upward are provided on an upper surface of the lid member 11. A positive electrode of the element is connected to the positive electrode external terminal 12P, and a negative electrode of the element is connected to the negative electrode external terminal 12N.

The two terminals 12 are arranged to be away from each other in the long-side direction of the lead-acid battery 1 in top view, and are arranged on one side (front side in the example illustrated in FIG. 1) with respect to the center in the short-side direction of the lead-acid battery 1 (direction orthogonal to an imaginary straight line 13 connecting the two terminals 12 when viewed from the direction perpendicular to a first wall portion). A gas vent hole (not illustrated) is formed in the lid member 11.

### (2) Packing Structure of Lead-Acid Battery

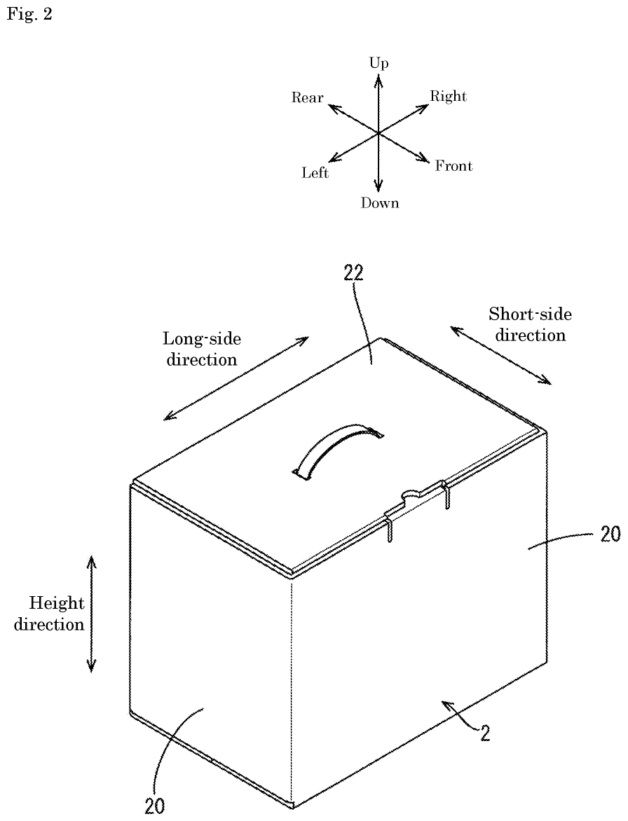

As illustrated in FIG. 2, the lead-acid battery 1 for replacement of a lead-acid battery mounted on an automobile is packaged in a packing box 2 (an example of a box) and sold. The packing box 2 is made of cardboard, and is formed in a rectangular parallelepiped shape having four side wall portions 20, a bottom wall portion 21 (see FIG. 4), and an upper wall portion 22. The upper wall portion 22 is an example of the first wall portion facing the two terminals 12 of the lead-acid battery 1. In the following description, the upper wall portion 22 is referred to as a first wall portion 22. The four side wall portions 20 are examples of wall portions continuous with the first wall portion 22 at a right angle. The short-side direction of the first wall portion 22 in top view is an example of a direction orthogonal to the imaginary straight line 13 when viewed from a direction perpendicular to the first wall portion 22 of the packing box 2.

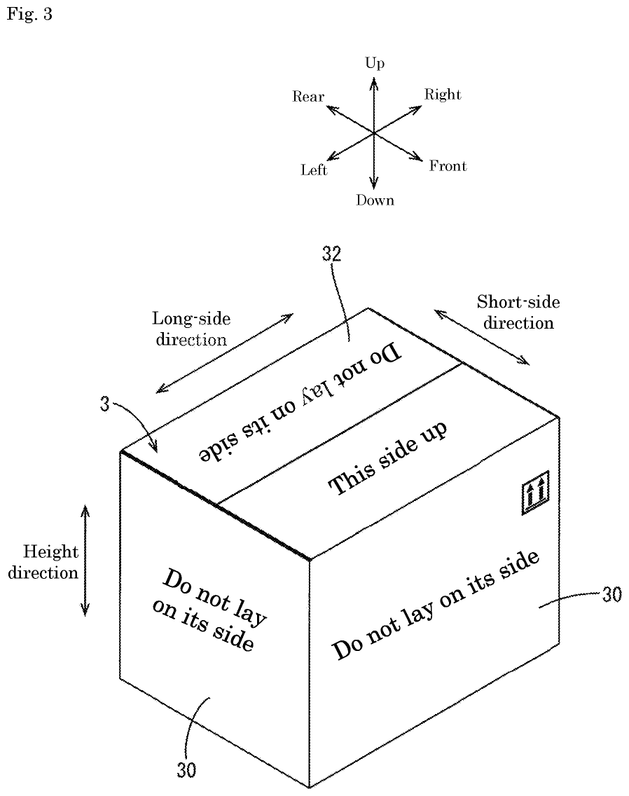

As illustrated in FIG. 3, when the lead-acid battery 1 for replacement is transported by air transportation or the like, the packing box 2 in which the lead-acid battery 1 is packed is accommodated in an individual transport box 3 (an example of an outer box) and transported. The transport box 3 is also made of cardboard and formed in a rectangular parallelepiped shape having four side wall portions 30, a bottom wall portion 31 (see FIG. 4), and an upper wall portion 32.

As illustrated in FIG. 4, a packing structure of the lead-acid battery 1 includes the packing box 2 in which the lead-acid battery 1 is packed, an inner bag 4 made of vinyl, two buffer bodies 5 for the lead-acid battery 1, a granular absorbent material 6, an outer bag 7 (an example of a bag) made of vinyl, and the transport box 3.

The packing box 2 is put in the transport box 3 in a state of being accommodated in the inner bag 4. The inner bag 4 is for preventing the electrolyte solution from leaking out to the outside of the transport box 3 when the lead-acid battery 1 falls during transportation and the electrolyte solution leaks out from the gas vent hole, when the electrolyte solution leaks out due to an impact of the transport box 3 falling during transportation, or the like.

The two buffer bodies 5 are for buffering an impact when the transport box 3 falls due to load collapse or the like during transportation. The two buffer bodies 5 have the same shape. One of the two buffer bodies 5 is disposed on the lower side of the packing box 2 put in the inner bag 4. The other of the buffer bodies 5 is disposed on the upper side of the packing box 2 put in the inner bag 4. The upper side is an example of an outer side of the first wall portion 22. In the following description, the buffer body 5 disposed on the upper side is referred to as an upper buffer body 5A, and the buffer body 5 disposed on the lower side is referred to as a lower buffer body 5B. A specific configuration of the buffer body 5 will be described later.

The granular absorbent material 6 is for absorbing the leaked electrolyte solution when the electrolyte solution leaked out from the lead-acid battery 1 leaks out from the inner bag 4. The granular absorbent material 6 is, for example, mica crushed into particles. The absorbent material 6 is not limited to mica, and can be appropriately selected.

The outer bag 7 is for preventing the leaked electrolyte solution from leaking out to the outside when the electrolyte solution leaks out from the inner bag 4.

### (3) Falling of Transport Box

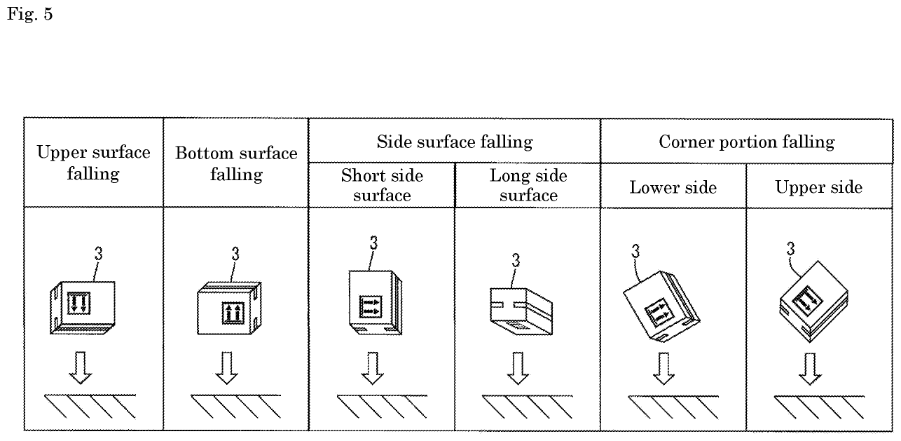

A form of falling of the transport box 3 will be described with reference to FIG. 5. As described above, the transport box 3 may fall due to load collapse or the like during transportation. The form of falling of the transport box 3 is divided into upper surface falling, bottom surface falling, side surface falling, and corner portion falling.

The upper surface falling is a form in which the transport box 3 falls with its upper surface facing downward.

The bottom surface falling is a form in which the transport box 3 falls with its bottom surface facing downward.

The side surface falling is a form in which the transport box 3 falls with its side surface facing downward. The side surfaces of the transport box 3 include a short side surface having a narrow width in the horizontal direction and a long side surface having a wide width in the horizontal direction. The side surface falling includes a case where the transport box 3 falls with its short side surface facing downward and a case where the transport box 3 falls with its long side surface falls downward.

The corner portion falling is a form in which the transport box 3 obliquely falls so as to collide with the floor from the corner portion of the transport box 3. The corner portion falling includes a case where the transport box 3 falls with its lower corner portion of the transport box 3 first and a case where the transport box 3 falls with its upper corner portion of the transport box 3 first.

When the transport box 3 falls, the lead-acid battery 1 may be damaged by the impact at the time of grounding, and the electrolyte solution stored inside may leak out. A standard of a drop test is set for marine products transported by an aircraft or a ship in order to ensure safety of the aircraft or the ship. According to this standard, it is required that the lead-acid battery 1 is not damaged even if the transport box 3 accommodating the lead-acid battery 1 is dropped from a height of about 1.3 m to 1.6 m.

### (4) Configuration of Buffer Body for Lead-Acid Battery

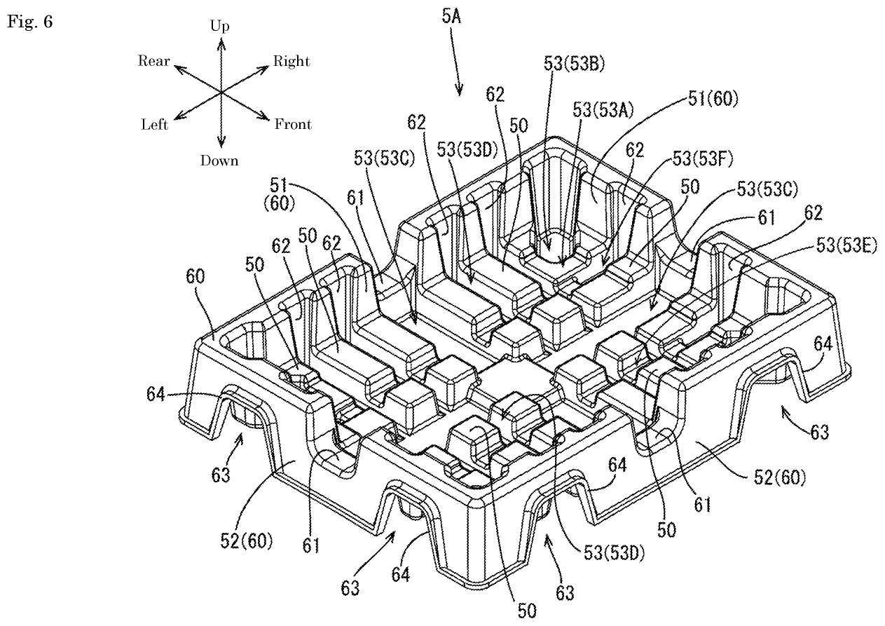

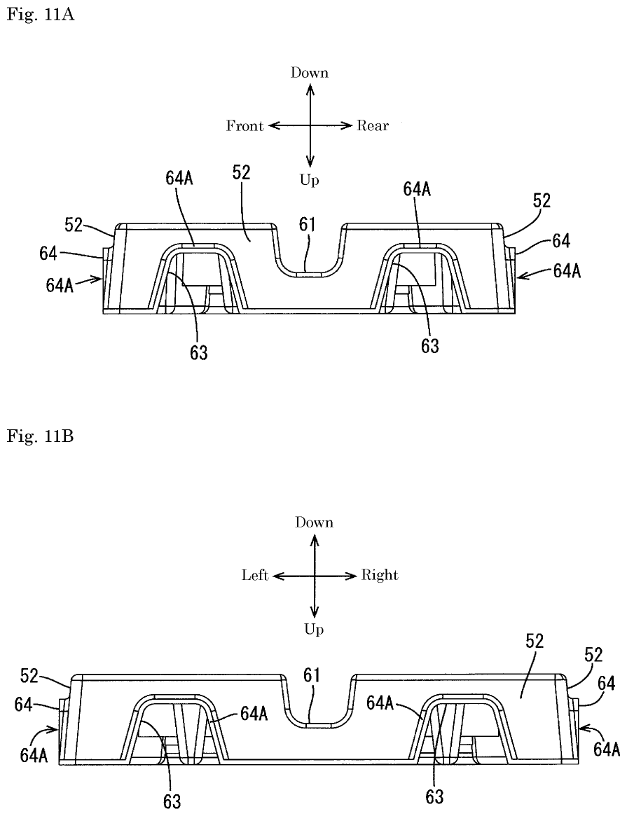

The buffer body 5 for the lead-acid battery 1 will be described with reference to FIGS. 6 to 11. Here, the upper buffer body 5A will be described as an example. For convenience, FIGS. 6 and 11 illustrate the upper buffer body 5A upside down. The shape of the upper buffer body 5A is a front-back target and is bilaterally symmetrical.

As illustrated in FIG. 6, the upper buffer body 5A includes a wall portion 50 whose outer peripheral shape substantially matches the outer peripheral shape of the first wall portion 22 of the packing box 2, a third wall portion 51 continuous with the outer peripheral edge portion of the wall portion 50, and a fourth wall portion 52 connected to the third wall portion 51. The wall portion 50 is an example of a second wall portion. In the following description, the wall portion 50 is referred to as a second wall portion 50. The third wall portion 51 extends downward from the outer peripheral edge portion of the second wall portion 50 over the entire circumference, and is formed in a frame shape surrounding the upper end portion of the packing box 2. The lower side of the fourth wall portion 52 is connected to the third wall portion 51, and is formed in a frame shape surrounding the third wall portion 51.

When the upper buffer body 5A is disposed on the packing box 2, the second wall portion 50 faces the first wall portion 22 of the packing box 2 with the inner bag 4 interposed therebetween. The second wall portion 50 is formed with a plurality of recessed portions 53 recessed upward (an example of a direction away from the first wall portion 22 of the packing box 2). The area of the second wall portion 50 other than the recessed portions 53 (in other words, the area of the second wall portion 50 in contact with the first wall portion 22 of the packing box 2) is 50% or more and 80% or less of the area of the second wall portion 50.

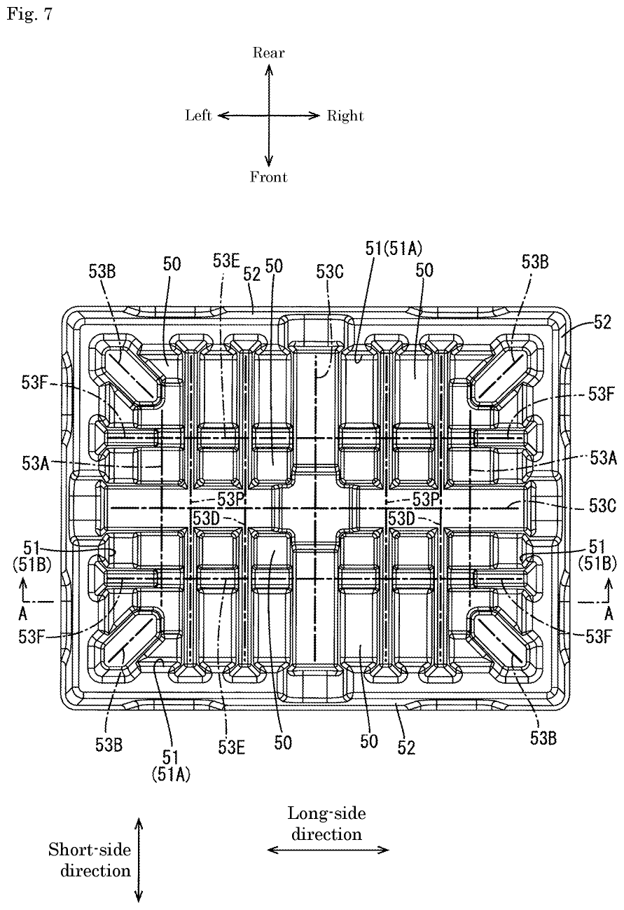

The plurality of recessed portions 53 will be specifically described with reference to FIG. 7. For convenience, in FIG. 7, the position of each recessed portion 53 is indicated by an alternate long and short dash line. The recessed portions 53 include two first recessed portions 53A, four second recessed portions 53B, a cross-shaped third recessed portion 53C, four fourth recessed portions 53D, two fifth recessed portions 53E, and four sixth recessed portions 53F. These recessed portions 53 may intersect each other or partially overlap each other.

The two first recessed portions 53A are away from each other in the long-side direction of the second wall portion 50 and extend in parallel in the short-side direction. The first recessed portions 53A are for buffering an impact applied to the two terminals 12 when the transport box 3 falls with its upper surface first.

The first recessed portion 53A extends to both sides in the short-side direction with respect to the center of the second wall portion 50 in the short-side direction (corresponding to the center of the packing box 2 in the short-side direction). In other words, the first recessed portion 53A is formed on both sides in the short-side direction with respect to the center of the packing box 2 in the short-side direction.

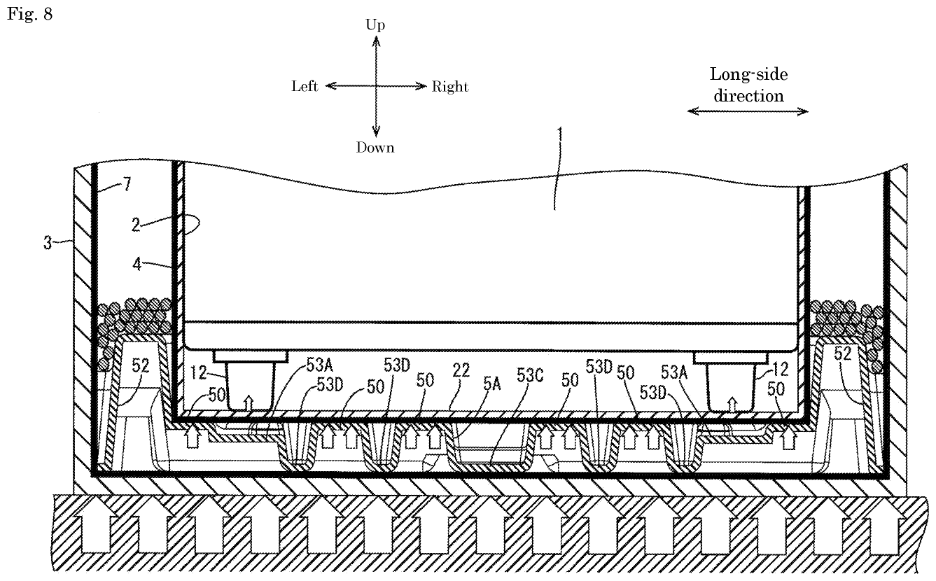

FIG. 8 is a partial cross-sectional view when the transport box 3 falls with its upper surface first. Although FIG. 8 illustrates a state where the transport box 3 is vertically inverted, when the transport box 3 is not vertically inverted, the left first recessed portion 53A of the two first recessed portions 53A is formed at a position immediately above the left terminal 12 (positive electrode external terminal 12P) of the lead-acid battery 1. The right first recessed portion 53A is formed at a position directly above the right terminal 12 (negative electrode external terminal 12N) of the lead-acid battery 1.

As illustrated in FIG. 8, the width of the first recessed portion 53A of the second wall portion 50 in the long-side direction is larger than the width of the terminal 12 in the long-side direction. Specifically, for example, the width of the first recessed portion 53A in the long-side direction is 1.3 times or more the width of the terminal 12 in the long-side direction. If the width of the first recessed portion 53A in the long-side direction is narrow, when the transport box 3 falls with its upper surface first and the first wall portion 22 of the packing box 2 is pressed downward by the terminal 12, the first wall portion 22 is hardly bent, and the cushioning property is impaired. Therefore, it is desirable that the width of the first recessed portion 53A in the long-side direction is wide to some extent.

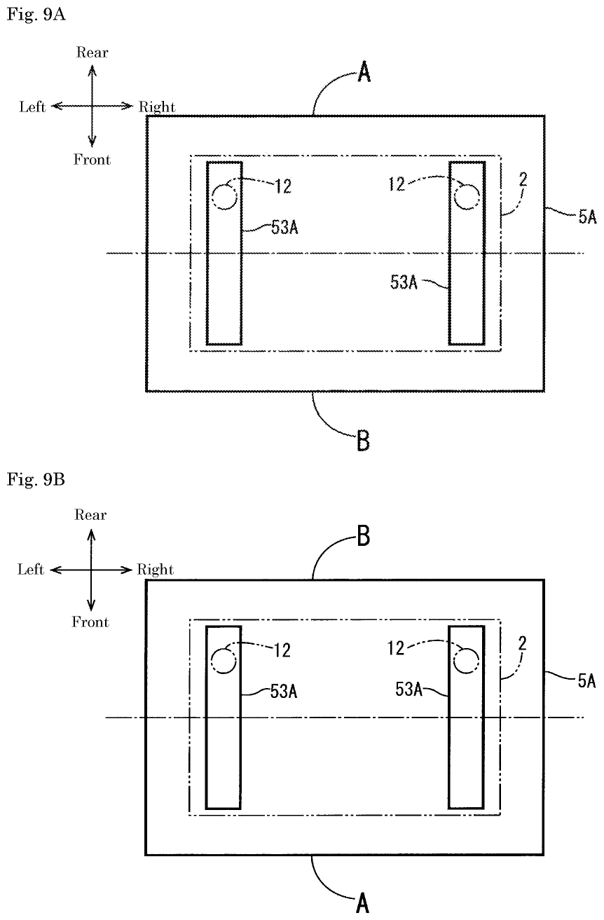

With reference to FIGS. 9A and 9B, the length of the first recessed portion 53A in the short-side direction will be described. For convenience, in FIG. 9A, one of two long sides of the upper buffer body 5A is a long side A, and the other is a long side B. The length of the first recessed portion 53A in the short-side direction is a length at which the first recessed portion 53A faces the terminal 12 even when the upper buffer body 5A is rotated by 180 degrees around a circular straight line (around a straight line perpendicular to the first wall portion 22 of the packing box 2). Specifically, FIG. 9B illustrates a state where the upper buffer body 5A is rotated by 180 degrees around a circular straight line so that the long side A and the long side B are interchanged. As illustrated in FIG. 9B, the first recessed portions 53A are located directly above the terminals 12 even when the upper buffer body 5A is rotated by 180 degrees.

As illustrated in FIG. 7, the four second recessed portions 53B are formed at corner portions formed by the second wall portion 50 and the third wall portion 51. The second recessed portion 53B is for protecting the lead-acid battery 1 from an impact when the transport box 3 falls with its corner portion first. Specifically, the square of the second wall portion 50 is recessed upward in a shape extending obliquely toward the center of the second wall portion 50 in top view. The third wall portion 51 is formed in a frame shape by two side walls 51A parallel to each other extending in the long-side direction and two side walls 51B parallel to each other extending in the short-side direction, and end portions of the side walls 51A and 51B in the length direction are recessed outward. As a result, the second recessed portion 53B is recessed so as to be away from the upper corner portion of the packing box 2.

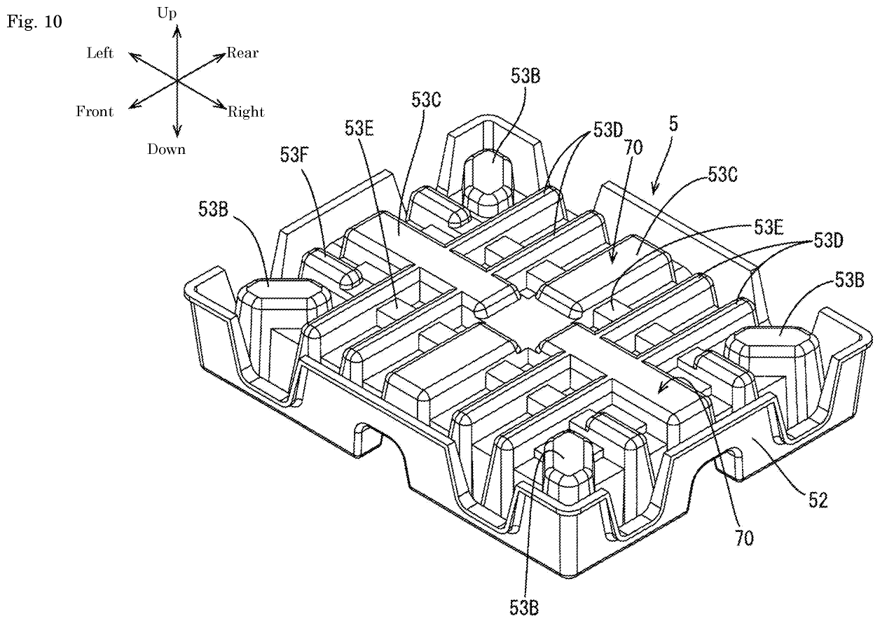

The cross-shaped third recessed portion 53C extends in a cross shape in the long-side direction and the short-side direction from the center of the second wall portion 50 in top view. A step is provided between the central portion of the third recessed portion 53C and the other portion of the third recessed portion 53C in order to improve the strength of the buffer body 5, and the central portion is located below the other portion. As illustrated in FIG. 10, the third recessed portion 53C has a flat surface 70 on a surface (surface facing upward) facing the side opposite to the first wall portion 22 of the packing box 2. When the opening of the outer bag 7 is fixed with an adhesive tape, an operator presses the adhesive tape against the flat surface 70. Since the adhesive tape has a certain width, the third recessed portion 53C also has a certain width in accordance with the width of the adhesive tape.

As illustrated in FIG. 7, the four fourth recessed portions 53D are away from each other in the long-side direction of the second wall portion 50 between the two first recessed portions 53A and extend in parallel to the short-side direction. Specifically, two fourth recessed portions 53D are formed on the right side and two fourth recessed portions 53D are formed on the left side with respect to the center of the buffer body 5 in the long-side direction.

The two fifth recessed portions 53E are away in the short-side direction of the second wall portion 50 and extend in parallel in the long-side direction. Specifically, one fifth recessed portion 53E is formed on the rear side and one fifth recessed portion 53E is formed on the front side with respect to the center of the buffer body 5 in the short-side direction. The fifth recessed portion 53E is deeper than the first recessed portion 53A, but is shallower than the recessed portions other than the first recessed portion 53A. The fifth recessed portion 53E is provided mainly for improving the strength of the second wall portion 50.

Each of the four sixth recessed portions 53F extends in the long-side direction from the end of the fifth recessed portion 53E.

Although FIG. 8 illustrates a state where the transport box 3 is vertically inverted, when the transport box 3 is not vertically inverted, the upper ends of the third recessed portion 53C and the fourth recessed portion 53D are located above the upper end of the first recessed portion 53A, which is the same as the position of the upper end of the fourth wall portion 52. Although not illustrated in FIG. 8, the positions of the upper ends of the second recessed portion 53B and the sixth recessed portion 53F are also the same as the positions of the upper ends of the third recessed portion 53C and the fourth recessed portion 53D. These recessed portions constitute hollow projecting portions projecting upward from the second wall portion 50. The hollow projecting portions are for protecting the lead-acid battery 1 from an impact when the transport box 3 falls with its upper surface first (in a case where the buffer body 5 is used as the lower buffer body 5B, the transport box 3 falls with its bottom surface first).

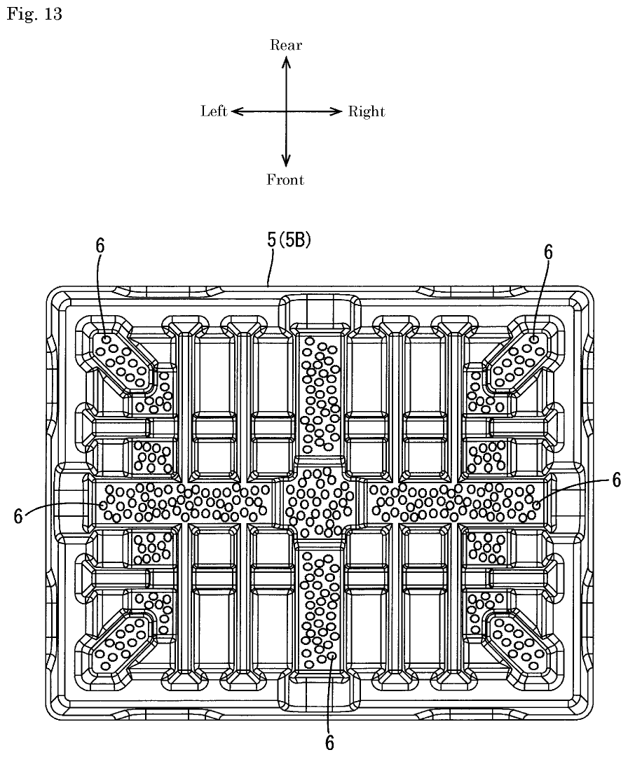

When the buffer body 5 is used as the lower buffer body 5B, the plurality of recessed portions 53 also serve as recessed portions in which the granular absorbent material 6 is disposed (see FIGS. 4 and 13).

The third wall portion 51 and the fourth wall portion 52 will be described with reference to FIGS. 4 and 6. As illustrated in FIG. 4, a space 65 is provided between the third wall portion 51 and the fourth wall portion 52. In the following description, a portion including the third wall portion 51 and the fourth wall portion 52 is referred to as a frame portion 60. As illustrated in FIG. 6, a recessed portion 61 recessed upward at the center in the long-side direction is formed in a portion of the frame portion 60 extending in the long-side direction of the second wall portion 50. A recessed portion 61 recessed upward at the center in the short-side direction is also formed in a portion extending in the short-side direction of the frame portion 60. These recessed portions 61 are for improving the strength of the frame portion 60.

A plurality of inverted triangular recessed portions 62 are formed on a surface facing the inside of the third wall portion 51. These recessed portions 62 are for improving the strength of the third wall portion 51. Specifically, in a portion of the third wall portion 51 extending in the long-side direction, two recessed portions are formed on one side and two recessed portions 62 are formed on the other side with respect to the center in the long-side direction. The apexes of these recessed portions 62 are continuous with the fourth recessed portions 53D. In a portion of the third wall portion 51 extending in the short-side direction, one recessed portion 62 is formed on one side and one recessed portion 62 is formed on the other side with respect to the center in the short-side direction. The apexes of these recessed portions 62 are continuous with the sixth recessed portions 53F.

As illustrated in FIGS. 11A and 11B, the fourth wall portion 52 is inclined downward so as to approach the packing box 2. In other words, the fourth wall portion 52 is inclined so as to approach the packing box 2 as being away from the second wall portion 50. As illustrated in FIG. 11A, in a portion of the fourth wall portion 52 extending in the short-side direction, recessed portions 63 recessed downward from the top are formed on both sides with the recessed portion 61 interposed therebetween. As illustrated in FIG. 11B, in a portion of the fourth wall portion 52 extending in the long-side direction, recessed portions 63 recessed downward from the top are formed on both sides with the recessed portion 61 interposed therebetween. These recessed portions 63 are for improving the strength of the fourth wall portion 52.

As illustrated in FIG. 6, a rib 64 is formed along an edge of the recessed portion 61 on an outer surface of the fourth wall portion 52. As illustrated in FIGS. 11A and 11B, the rib 64 has a surface 64A parallel to the side wall portion 20 of the packing box 2.

### (5) Accommodation of Lead-Acid Battery in Transport Box

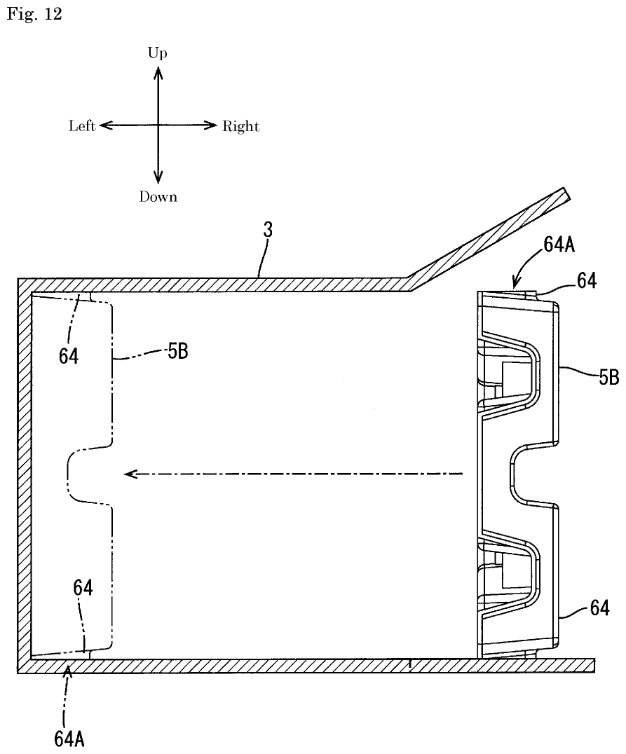

With reference to FIGS. 4, 12, and 13, accommodation of the lead-acid battery 1 in the transport box 3 will be described. As illustrated in FIG. 4, in accommodating the lead-acid battery 1 in the transport box 3, first, the outer bag 7 is accommodated inside the transport box 3, and the lower buffer body 5B is accommodated inside the outer bag 7. As illustrated in FIG. 12, when accommodating the lower buffer body 5B, the operator may lay the transport box 3 on its side for ease of operation and accommodate the lower buffer body 5B in a standing state (state where the outer surface of the fourth wall portion 52 faces downward). Since the side wall portion 20 of the packing box 2 and the side wall portion 30 of the transport box 3 are parallel to each other, when the lower buffer body 5B is accommodated in a standing state, the parallel surface 64A of the rib 64 comes into contact with the side wall portion 30 of the transport box 3, so that the buffer body 5 is less likely to fall.

Next, the transport box 3 is returned to the original posture (posture opened upward). After the transport box 3 is returned to the original posture, as illustrated in FIG. 13, the granular absorbent material 6 is disposed in the recessed portion 53 of the lower buffer body 5B. FIG. 13 illustrates a case where the absorbent material 6 is disposed only in some of the recessed portions 53, but the absorbent material 6 is disposed in all the recessed portions 53. After the absorbent material 6 is disposed in the recessed portions 53, the packing box 2 put in the inner bag 4 is disposed on the lower buffer body 5B as illustrated in FIG. 4. Next, the granular absorbent material 6 is further put between the side wall portion 30 of the transport box 3 and the side wall portion 20 of the packing box 2 (specifically, between the outer bag 7 and the inner bag 4). After the absorbent material 6 is put, the upper buffer body 5A is disposed on the packing box 2 put in the inner bag 4.

Next, the upper end portion of the outer bag 7 is folded on the upper buffer body 5A. After the upper end portion of the outer bag 7 is folded, the outer bag 7 is sealed by attaching an adhesive tape to the folded portion of the outer bag 7. At this time, the operator presses the adhesive tape against the surface 70 facing the upper side of the third recessed portion 53C (the surface facing the side opposite to the first wall portion 22). Thereafter, the upper opening of the transport box 3 is closed and sealed with an adhesive tape or the like.

### (6) Absorption of Impact by Buffer Body

As illustrated in FIG. 8, when the transport box 3 falls with its upper surface first, the first wall portion 22 of the packing box 2 is pressed downward by the terminals 12 of the lead-acid battery 1. The pressed first wall portion 22 functions as a cushion by being bent downward using the space of the first recessed portion 53A of the upper buffer body 5A. As a result, the impact applied to the terminals 12 is buffered, and the impact is dispersed to the entire first wall portion 22 of the packing box 2.

Furthermore, when the transport box 3 falls with its upper surface first, the projecting portions (second recessed portions 53B, third recessed portion 53C, fourth recessed portions 53D, and sixth recessed portions 53F) being hollow and projecting upward from the second wall portion 50 (downward in FIG. 8 since the upper and lower sides are reversed) receives an impact from the floor. Since the hollow projecting portions are crushed when receiving an impact, the impact on the lead-acid battery 1 can be further buffered by crushing the hollow projecting portions and absorbing the impact.

As illustrated in FIG. 5, even when the transport box 3 falls with its bottom surface first, the impact is buffered by the hollow projecting portions of the lower buffer body 5B being crushed.

When the transport box 3 falls with its side surface first, the impact of the side surface falling is buffered by bending of the fourth wall portion 52 toward the third wall portion 51 or bending of the third wall portion 51 toward the fourth wall portion 52.

When the transport box 3 falls with its corner portion first, concentration of an impact on the corner portion of the lead-acid battery 1 is suppressed by the presence of the second recessed portions 53B.

### (7) Effects of Embodiment

According to the buffer body 5 of the first embodiment, when the transport box 3 falls with its upper surface first, the first wall portion 22 pressed downward by the terminals 12 bends downward using the spaces of the first recessed portions 53A to function as a cushion, so that the impact applied to the terminals 12 is buffered and the impact is dispersed to the entire first wall portion 22 of the packing box 2. As a result, it is possible to reduce the possibility that the impact concentrates on the terminals 12 and the lead-acid battery 1 is damaged. Furthermore, since the buffer body 5 is made of pulp mold, even if the lead-acid battery 1 is damaged and the electrolyte solution leaks out, the leaked electrolyte solution can be absorbed to some extent by the buffer body 5. Therefore, according to the buffer body 5, it is possible to improve a problem unique to the case of transporting the lead-acid battery 1 (a problem that the lead-acid battery 1 may be damaged during transportation, and the electrolyte solution may leak out and affect the surroundings).

For example, the buffer body 5 can be formed by overlapping cardboard plates, but since the cardboard plates have a smooth surface, there is a problem that the packing box 2 slides inside the transport box 3 during transportation, and the position is difficult to be stabilized. On the other hand, since a buffer body made of pulp mold has a rough surface, there is also an advantage that the packing box 2 is difficult to slip.

In general, since the cardboard plate has sharp corners, an operator may be injured when accommodating the buffer body 5 in the outer bag 7 or the outer bag 7 may be broken at the corners of the cardboard. Since the buffer body made of pulp mold has less sharp corners than a buffer body made of cardboard, it is possible to reduce the possibility that the operator is injured or the outer bag 7 is broken.

When the buffer body 5 is formed by overlapping the cardboard plates, an adhesive is required. However, when the buffer body 5 is made of pulp mold, an adhesive is not required, and a process of overlapping the cardboard plates is not required. Therefore, there is also an advantage that the buffer body 5 can be manufactured at a lower cost than that of the buffer body 5 made of cardboard plates.

Since the pulp mold is easy to mold a complicated shape as compared with the buffer body 5 made of cardboard plates, there is also an advantage that the shape can be easily devised so as to buffer the impact.

For example, it is also possible to use a buffer body 5 made of foamed polystyrene as the buffer body 5, but the foamed polystyrene has a problem that the combustion temperature becomes high during incineration, and an incinerator is damaged early, and a problem that a harmful gas is generated. On the other hand, the buffer body 5 made of pulp mold has an advantage that such a problem can be improved.

According to the buffer body 5, even when the buffer body 5 is rotated by 180 degrees around a straight line perpendicular to the first wall portion 22 of the packing box 2, the first recessed portions 53A face the terminals 12, so that the operator does not need to pay attention to the direction of the buffer body 5 when arranging the buffer body 5. Therefore, operability is improved.

According to the buffer body 5, since the tips of the hollow projecting portions are spaced apart from the first wall portion 22 of the packing box 2 from the tips of the first recessed portions 53A, when the transport box 3 falls with its upper surface first, an impact from the floor is received by the hollow projecting portions. Since the hollow projecting portions are crushed when receiving an impact, the projecting portions are crushed to buffer the impact, so that it is possible to further buffer the impact when the transport box 3 falls with its upper surface first. When the buffer body 5 is used as the lower buffer body 5B, the impact when the transport box 3 falls with its bottom surface first is buffered by the hollow projecting portions.

According to the buffer body 5, since the space 65 is provided between the third wall portion 51 and the fourth wall portion 52 constituting the frame portion 60, when the transport box 3 falls with its side surface first, the fourth wall portion 52 bends using the space 65 or the third wall portion 51 bends using the space 65, thereby functioning as a cushion that buffers the impact applied to the lead-acid battery 1. Therefore, it is possible to buffer the impact when the transport box 3 falls with its side surface first.

According to the buffer body 5, since the rib 64 having the surface 64A parallel to the side wall portion 20 (the wall portion continuous with the first wall portion 22 at a right angle) of the packing box 2 is formed on the outer surface of the fourth wall portion 52, when the buffer body 5 is accommodated in a standing state, the parallel surface 64A of the rib 64 comes into contact with the side wall portion 30 of the transport box 3, so that the buffer body 5 is less likely to fall. Therefore, operability is improved.

According to the buffer body 5, since the third recessed portion 53C recessed so as to be away from the corner portion of the packing box 2 is formed, it is possible to suppress concentration of an impact on the corner portion of the lead-acid battery 1 when the transport box 3 falls with its corner portion first. Therefore, it is possible to reduce the possibility that the impact concentrates on the corner portion and the lead-acid battery 1 is damaged.

According to the buffer body 5, since the flat surface 70 is formed on the surface of the second wall portion 50 of the buffer body 5 facing the side opposite to the packing box 2, the operator can easily attach the adhesive tape by pressing the adhesive tape against the flat surface 70. Therefore, operability is improved.

According to the buffer body 5, since the recessed portions 53 are formed in the lower buffer body 5B, the granular absorbent material 6 can be disposed in the recessed portions 53. Conventionally, after the packing box 2 is accommodated in the transport box 3, the absorbent material 6 is put between the side surface of the transport box 3 and the side surface of the packing box 2, and the absorbent material 6 is not disposed under the packing box 2. For this reason, there is a bias in the arrangement of the absorbent material 6 inside the transport box 3. According to the buffer body 5, it is possible to reduce the bias of the absorbent material 6 inside the transport box 3 by arranging the absorbent material 6 in the recessed portions 53. Therefore, the leaked electrolyte solution can be more reliably absorbed.

According to the buffer body 5, the area of the portion other than the recessed portions 53 in the second wall portion 50 of the buffer body 5 is 50% or more and 80% or less of the area of the second wall portion 50. If the area of the portion other than the recessed portions 53 (the portion in contact with the bottom wall portion 21 of the packing box 2) in the second wall portion 50 is too small, the lower buffer body 5B may not be able to sufficiently buffer the impact. On the other hand, when the area of the portion other than the recessed portions 53 is too large, the amount of the absorbent material 6 that can be disposed under the packing box 2 decreases, and the absorbability of the electrolyte solution decreases. As a result of intensive studies, the inventors of the present application have found that when the area of the portion other than the recessed portions 53 in the second wall portion 50 is 50% or more and 80% or less of the area of the second wall portion 50, both buffering of the impact and absorption of the electrolyte solution can be achieved in a well-balanced manner. According to the buffer body 5, since the area of the portion other than the recessed portions 53 in the second wall portion 50 is 50% or more and 80% or less of the area of the second wall portion 50, both buffering of the impact and absorption of the electrolyte solution can be achieved in a well-balanced manner.

According to the buffer body 5, the first recessed portions 53A extend in the short-side direction of the lead-acid battery 1 when viewed from above. The lead-acid battery 1 has a plurality of sizes, and the positions of the terminals 12 in the short-side direction may vary depending on the size. When the first recessed portions 53A extend in the short-side direction of the lead-acid battery 1, the first recessed portions 53A are located directly above the terminals 12 even if the sizes of the lead-acid batteries 1 are different, so that the buffer body 5 can be commonly applied to lead-acid batteries 1 of different sizes. Therefore, the efficiency is higher than that in a case where the buffer body 5 is prepared for each size.

According to the buffer body 5, the first recessed portion 53A also has a certain width in the long-side direction of the lead-acid battery 1 when viewed from above. The lead-acid battery 1 has a plurality of sizes, and the positions of the terminals 12 in the long-side direction may vary depending on the size. When the first recessed portion 53A has a certain width in the long-side direction of the lead-acid battery 1, the first recessed portions 53A are located directly above the terminals 12 even if the sizes of the lead-acid batteries 1 are different, so that the buffer body 5 can be commonly applied to lead-acid batteries 1 of different sizes. Therefore, the efficiency is higher than that in a case where the buffer body 5 is prepared for each size.

According to the packing structure of the first embodiment, it is possible to improve a problem unique to the case of transporting the lead-acid battery 1.

### Other Embodiments

The present invention is not limited to the embodiments described with reference to the above description and drawings, and for example, the following embodiments are also included in the technical scope of the present invention.

(1) In the first embodiment described above, the case has been described as an example where the first recessed portion 53A is formed on both sides in the short-side direction with respect to the center in the short-side direction, and the first recessed portion 53A faces the terminal 12 even when the buffer body 5 is disposed while being rotated by 180 degrees around a straight line perpendicular to the first wall portion 22. On the other hand, the first recessed portion 53A may be formed only on one side in the short-side direction with respect to the center in the short-side direction. However, in that case, it is necessary to pay attention to the direction when arranging the upper buffer body 5A.

(2) In the first embodiment described above, the case has been described as an example where the lower ends (tips) of the hollow projecting portions of the upper buffer body 5A is located below the lower end of the first recessed portion 53A, but the lower ends of the hollow projecting portions may be located at the same position as the lower end of the first recessed portion 53A. In this case, when the transport box 3 falls with its upper surface first or its bottom surface first, an impact is also received by the first recessed portion 53A.

(3) In the embodiment described above, the case where the terminals 12 are provided on the upper surface of the lead-acid battery 1 has been described as an example, but the surface on which the terminals 12 are provided is not limited to the upper surface. For example, the terminals 12 may be provided on the side surface of the lead-acid battery 1.

(4) In the first embodiment described above, the lead-acid battery 1 mounted on an automobile has been described as an example, but the lead-acid battery 1 is not limited to one mounted on an automobile. For example, the lead-acid battery 1 may be mounted on a motorcycle or may be used for other purposes.

### DESCRIPTION OF REFERENCE SIGNS

1: lead-acid battery
2: packing box (example of box)
3: transport box (example of outer box)
5: buffer body
7: outer bag (example of bag)
12: terminal
13: imaginary straight line
22: first wall portion
50: second wall portion
51: third wall portion
52: fourth wall portion
53A: first recessed portion
53B: second recessed portion (example of projecting portion being hollow)
53C: third recessed portion (example of projecting portion being hollow)
53D: fourth recessed portion (example of projecting portion being hollow)
53F: sixth recessed portion (example of projecting portion being hollow)
64: rib
64A: parallel surface
65: space (example of space between third wall portion and fourth wall portion)
70: flat surface

1. A buffer body for a lead-acid battery having two terminals,
the buffer body being made of pulp mold,
the buffer body comprising, in a state where the buffer body is disposed outside a first wall portion facing the two terminals among wall portions of a box in which the lead-acid battery is packed:
a second wall portion facing the first wall portion; and
a first recessed portion formed at a position facing the terminal in the second wall portion and recessed in a direction away from the first wall portion.

2. The buffer body for a lead-acid battery according to claim 1,
wherein the two terminals are arranged on the same side in a direction orthogonal to an imaginary straight line connecting the two terminals with respect to a center of the box in the direction orthogonal to the imaginary straight line when viewed from a direction perpendicular to the first wall portion of the box, and
wherein the first recessed portion is formed on both sides in the orthogonal direction with respect to the center of the box, and the first recessed portion faces the terminal even when the buffer body is disposed while being rotated by 180 degrees around a straight line perpendicular to the first wall portion.

3. The buffer body for a lead-acid battery according to claim 1,
wherein the second wall portion has a projecting portion being hollow and protruding in a direction away from the first wall portion, and a tip of the projecting portion is at the same position as a tip of the first recessed portion or is farther from the first wall portion than the tip of the first recessed portion.

4. The buffer body for a lead-acid battery according to claim 1, further comprising:
a third wall portion having a frame shape that is continuous with an outer peripheral edge portion of the second wall portion and surrounds the box; and
a fourth wall portion having a frame shape that is connected to the third wall portion and surrounds the third wall portion,
wherein a space is provided between the third wall portion and the fourth wall portion.

5. The buffer body for a lead-acid battery according to claim 4,
wherein the fourth wall portion is inclined so as to approach the box as being away from the second wall portion, and
wherein a rib having a surface parallel to a wall portion continuous with the first wall portion at a right angle among wall portions of the box is formed on an outer surface of the fourth wall portion.

6. The buffer body for a lead-acid battery according to claim 4,
wherein a second recessed portion recessed so as to be away from a corner portion of the box is formed in the second wall portion and the third wall portion.

7. The buffer body for a lead-acid battery according to claim 1,
wherein the box and the buffer body are transported in a state of being put in a bag, and
wherein, on a surface of the second wall portion facing a side opposite to the first wall portion, a flat surface for pressing an adhesive tape when an opening of the bag is fixed with the adhesive tape is formed.

8. A packing structure of a lead-acid battery having two terminals, the packing structure comprising:
the box in which the lead-acid battery is packed;
an outer box in which the box is accommodated; and
the buffer body for a lead-acid battery according to claim 1, which is disposed outside the first wall portion of the box inside the outer box.
